(19) United States
(12) Patent Application Publication
(10) Pub. No.: US 2015/0074289 A1
(43) Pub. Date: Mar. 12, 2015

(54) DETECTING ERROR PAGES BY ANALYZING SERVER REDIRECTS

(71) Applicants: Joshua Mark HYMAN, Encino, CA (US); Joseph Lawrence WHITE, Malibu, CA (US); Justin Gabriel DONNELLY, Westlake Village, CA (US); Joseph Gregory BILLOCK, Altadena, CA (US)

(72) Inventors: Joshua Mark HYMAN, Encino, CA (US); Joseph Lawrence WHITE, Malibu, CA (US); Justin Gabriel DONNELLY, Westlake Village, CA (US); Joseph Gregory BILLOCK, Altadena, CA (US)

(73) Assignee: GOOGLE INC., Mountain View, CA (US)

(21) Appl. No.: 13/491,547

(22) Filed: Jun. 7, 2012

Related U.S. Application Data
(60) Provisional application No. 61/581,041, filed on Dec. 28, 2011.

(51) Int. Cl. G06F 15/16

(52) U.S. Cl. 709/245

(57) ABSTRACT

A system and method is disclosed for detecting invalid webpages by analyzing server redirects. A storage comprising a set of previously stored target addresses is queried to determine whether one or more of the set of previously stored target addresses result from a redirect initiated from more than a predetermined number of originating addresses. On determining that a target address resulted from a redirect initiated from more than the predetermined number of originating addresses, the originating addresses are analyzed to determine, for each address, a difference between information previously stored for the originating address and information associated with the respective target address. If the difference satisfies a predetermined threshold, the originating address is marked as not valid or is removed.

The present application claims priority benefit under 35 U.S.C. §119(e) from U.S. Provisional Application No. 61/581,041, filed Dec. 28, 2011, which is incorporated herein by reference in its entirety.

### BACKGROUND

When a webpage is removed or becomes no longer available, a HTTP standard response error message of “404” or “not found” may be returned. However, some sites may redirect the web address of a removed or no longer available webpage to a web address that returns valid content. The new redirection may increase the difficulty of, for example, preclude from, a web crawler determining that the original webpage is no longer available. Some members of the web community have termed this behavior as a “soft (or crypto) 404”

### SUMMARY

The subject technology provides a system and computer-implemented method for detecting invalid webpages by analyzing server redirects. According to some aspects, a computer-implemented method may include analyzing previously stored target addresses, determining one or more of the previously stored target addresses that result from more than a predetermined number of redirected originating addresses, and, on determining a respective target address, determining that one or more corresponding originating addresses are invalid based on a difference between information previously stored for the one or more corresponding originating addresses and information associated with the respective target address. Other aspects include corresponding systems, apparatus, and computer program products for implementation of the computer implemented method.

The previously described aspects and other aspects may include one or more of the following features. For example, the one or more corresponding originating address may be determined to be invalid when the difference satisfies a predetermined threshold. The method may further include analyzing resources corresponding to a plurality of resource addresses, the plurality of resource addresses including the redirected originating addresses, wherein the previously stored information is derived from resources located at the redirected originating addresses. In this regard, a resource address may be an internet address, and the analyzed resources include webpages located at respective internet addresses, and wherein analyzing the resources includes performing a web crawling operation on a plurality of webpages.

The information previously stored for an originating address may also include content associated with a webpage located at the originating address, and the information associated with the respective target address may include content associated with a webpage located at the respective target address. Additionally or in the alternative, information previously stored for an originating address may include a first set of meta-data associated with the originating address, and the information associated with the respective target address includes a second set of meta-data associated with the respective target address. The method may also include determining a first plurality of n-grams based on terms in information previously stored for an originating address, determining a second plurality of n-grams based on terms in the information associated with the respective target address, comparing the first plurality and the second plurality, and determining a number of matching n-grams between the first plurality and the second plurality, wherein the difference is based on the determined number of matching n-grams. In this regard, the method may further include, before determining the first plurality of n-grams, excluding terms that are in a group of stop words, and, before determining the second plurality of n-grams, excluding terms that are in the group of stop words.

The method may include determining a first semantic content based on terms in the information previously stored for an originating address, determining a second semantic content based on terms in the information associated with the respective target address, and comparing the first semantic content with the second semantic content, wherein the difference is representative of a number of meanings found between the first semantic content and the second semantic content. Additionally or in the alternative, the method may include storing the one or more corresponding originating addresses, indexed by the respective target address. The redirected originating addresses may include one or more intermediate redirecting addresses between a first redirecting address and a final target address. The method may include providing an indication that the one or more corresponding originating addresses are not valid. In this regard, providing the indication may include removing the one or more corresponding originating addresses from a searchable set of originating addresses.

In other aspects, a machine-readable media may include instructions thereon that, when executed, perform a method. In this regard, the method may include determining one or more target addresses that result from a redirection from one or more originating addresses, and, for a target address, storing a plurality of originating addresses, determining that a number of the plurality of originating addresses satisfies a predetermined threshold, and, on determining that the plurality of originating addresses satisfies the predetermined threshold, providing an indication that the plurality of originating addresses is not valid. Other aspects include corresponding systems, apparatus, and computer program products for implementation of the computer implemented method.

The previously described aspects and other aspects may include one or more of the following features. For example, the method may further include analyzing a plurality of webpage addresses to determine the one or more target addresses. Determining the one or more target addresses may include determining one or more intermediary addresses that result from the redirection, the one or more target addresses being a result of a redirection from the one or more intermediary addresses, and storing the one or more intermediary addresses in the storage location together with the plurality of originating addresses. In this regard, the method may also include, for an intermediary address, if the plurality of originating addresses related to the intermediary address satisfies the predetermined threshold, providing an indication that the intermediary addresses is not valid. Additionally or in the alternative, the method may include storing the one or more target addresses in a storage location, and analyzing the storage location to determine how many originating addresses redirect to each stored target address. Providing an indication that an originating address is not valid may include removing the originating address from the plurality of originating addresses, and from a subsequent web crawling operation.

A system may include a processor and a memory. The memory may include server instructions that, when executed, cause the processor to analyze (for example, scan) a plurality of internet addresses, store information corresponding to the plurality of internet addresses, from the plurality of internet addresses, determine one or more target addresses redirected from the plurality of internet addresses, store the one or more target addresses in a storage location, and, for a target address, store a plurality of originating addresses, determine a number of the plurality of originating addresses, and, on determining that the number satisfies a first predetermined threshold, identify originating addresses associated with resources that include different information than a resource associated with the target address, and providing an indication that the identified originating addresses are not valid.

The previously described aspects and other aspects may provide one or more advantages, including, but not limited to, providing a mechanism to more easily discover soft 404 behavior when using, for example, an automatic process to examine websites (for example, in a web crawling operation), and providing the ability to automatically exclude hyperlinks or web addresses (for example, uniform resource locators (URLs)) that no longer link to content they represent from search results and other information that would otherwise display those hyperlinks. Thus, when a set of information, including hyperlinks or web addresses, is requested, the information may be provided in an efficient manner by limiting the displayed information to only valid content, saving a user the time and effort of analyzing invalid content.

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of example processes for performing a method of detecting invalid webpages by analyzing server redirects.

FIG. 2 is an example of a computer-enabled system for detecting invalid webpages by analyzing server redirects.

FIG. 3 is a flowchart illustrating an example process for detecting invalid webpages by analyzing server redirects.

FIG. 4 is a diagram illustrating an example machine or computer for detecting invalid webpages by analyzing server redirects, including a processor and other internal components.

### DETAILED DESCRIPTION

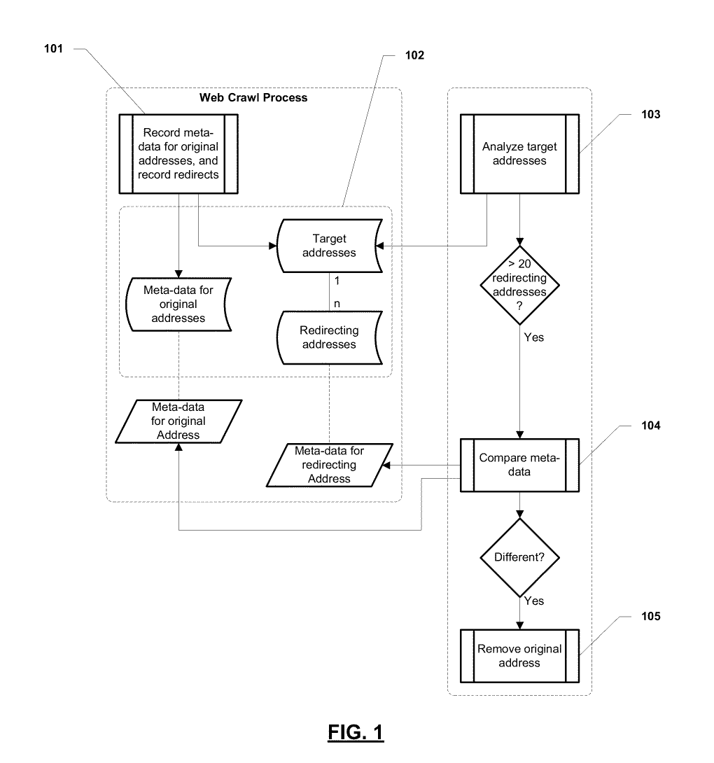

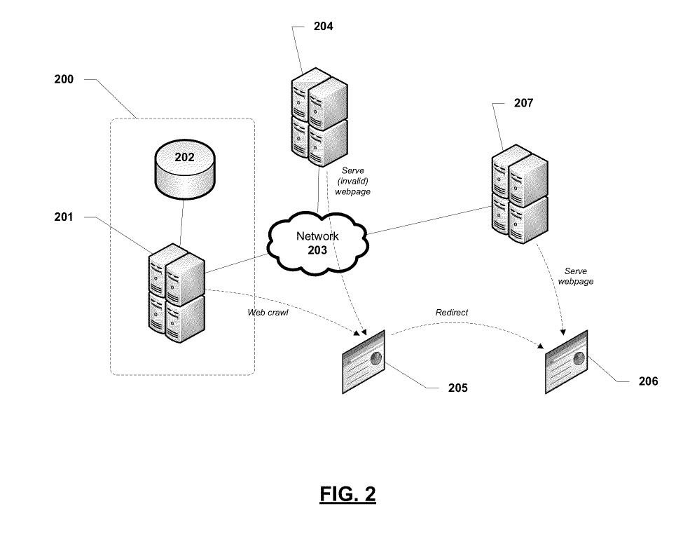

FIG. 1 is a diagram of example processes (for example, batch processes) for performing a method of detecting invalid webpages by analyzing server redirects according to some aspects of the subject technology. The subject technology provides one or more servers (for example, first server 201 of FIG. 2) configured to execute one or more processes, including, for example, techniques directed to implementing the methods described herein. In one example, a server may perform a process 101 (for example, a web crawling process) on a group of online resources (for example, webpages). Process 101 may analyze (for example, scan) a group of internet addresses corresponding to the online resources, and attempt to access online content located at each internet address. Process 101 may then store (for example, in a database or other storage) information derived from one or more online resources located at each analyzed internet address. Online resources may include webpages, files within an FTP site, RSS feeds, or the like. The information may include content displayed in connection with the resource, for example, displayed on a webpage, or meta-data associated with the analyzed resource, for example, embedded within the webpage.

Process 101 may determine (for example, identify), from the analyzed internet addresses, one or more addresses that initiate a redirect (for example, a URL redirection, URL forwarding, domain redirection, or the like). Each time a redirect is detected, a target of the redirect may be stored in a storage location 102. Process 101 may then store an entry for each originating address that initiates a redirect to the target address. For example, if a redirect is detected during analysis (for example, on a scan) of an address, and the address initiates a redirect to a target address already stored in storage location 102, then that address may be stored in storage location 102, indexed by the target address. In this regard, the stored addresses that initiate a redirect may include intermediary redirecting addresses (for example, addresses that initiate a redirect between the first redirecting address and final address) stored in the same manner. Thus, there may be n number of originating addresses stored for each target address.

A process 103 may connect to storage location 102 to analyze (for example, scan) one or more sets of previously stored target addresses. Process 103 may query storage location 102 to determine how many originating addresses redirect to each stored target address, and determine whether one or more previously stored target addresses resulted from a redirect initiated from more than a predetermined number (for example, twenty) of originating addresses. Process 103 may, for example, read a counter set by process 101, or may count the number of originating addresses currently associated with an analyzed target address.

On determining that a target address results from a redirect initiated from more than the predetermined number of originating addresses, a first sub-process 104 may determine a data difference (for example, a variance, standard deviation, or the like) between the information previously stored for the originating address (for example, content associated with a webpage located at the originating address) with information associated with the respective target address (for example, content associated with a webpage located at the target address). In some aspects, the data difference may include a difference between a previously stored first set of information (for example, content or meta-data from a first webpage) corresponding to the originating address, and a second set of information (for example, content or meta-data from a second webpage) currently associated with the target address.

In some aspects, the data difference may be based on an n-gram comparison of the first set of information and the second set of information. For example, a set of n-grams (for example, a set of n adjacent tokens, for example, words or characters) may be constructed for each of the first and second sets of information. First sub-process 104 may then perform a text or character-based comparison of the respective sets of n-grams to determine a difference between the first and second sets. For example, first sub-process 104 may determine a ratio of commonly found terms to a number of terms compared.

In one example, sub-process 104 may determine a first group of bi-grams (for example, pairs of tokens) based on terms in the first set of information, and a second group of bi-grams based on terms in the corresponding second set of information. In some aspects, prior to determining the bi-grams, first sub-process 104 may exclude terms within first set, and terms within the second set, that are in a group of predetermined stop words. The first group and the second group may then be compared to each other to determine a number of matching bi-grams between the first group and the second group. In this example, the determined number of matching bi-grams may represent the previously described data difference, or may be used to generate the data difference (for example, by a normalization of the determined number).

In other aspects, a semantic comparison may be performed. For example, first process 202 may access a stored group of terms associated with one or more semantic meanings, each term being assigned a metric value representative of a likelihood that the term is related to a corresponding meaning. A first semantic content set may be determined based on a comparison of the group of terms and the previously described first set of information, and a second semantic content set may be determined based on a comparison of the group of terms with the second set of information. The first semantic content set may be compared with the second semantic content set, to determine a data difference, representative of a number of meanings found between the first semantic content and the second semantic content.

If the data difference satisfies (for example, reaches, exceeds, or the like) a predetermined threshold (for example, a preset value, or an average, or standard deviation from the mean, of a difference found between data associated with a sample set of originating and target addresses), a second sub-process 105 may provide an indication that the originating address corresponding to the determined difference is not valid. In this regard, the indication may include setting a flag in storage location 102, or may include removing the originating address from storage location 102 (for example, from a searchable set of originating addresses that initiate a redirect resulting in the respective target address). Accordingly, the flagged or removed originating address may be removed from a subsequent web crawling operation (for example, by not being available to the operation, or by the operation excluding flagged addresses). It is also noted, that, in some aspects, a data difference may not be determined for a target address, and, the indication that the originating addresses that redirect to the target address are not valid (for example, removed or flagged) may be made on determining the predetermined number of originating addresses for a target.

FIG. 2 is an example of a computer-enabled system 200 for performing a method for detecting invalid webpages by analyzing server redirects according to some aspects of the subject technology. System 200 may include one or more first servers 201 and one or more storage locations 202. First servers 201 may include instructions for implementing the processes described herein. In one example, first servers 201 may perform one or more web crawling operations to analyze and index webpages accessible over a network 203 (for example, the Internet, a local area network, wide area network, cellular network, or the like), including analyzing information (for example, visible or embedded content) provided by the webpages. During a web crawling operation, for example, the information corresponding to each analyzed webpage may be stored in storage locations 202.

One or more second servers 204 may serve one or more websites (including one or more webpages 205) to users over network 203. In some aspects, one or more webpages 205 served by second servers 204 may be removed or otherwise become no longer available. Site owners for the one or more removed webpages 205 may provide instructions, for example, to configure corresponding second servers 204 to redirect the web address of a removed or no longer available webpage 205 to a web address of an available webpage 206 that returns valid content. In this regard, removing a webpage 205 may include removal of content originally displayed on the webpage and replacing it with code that causes the redirect. Available webpage 206 may be located on second servers 204, or on a different one or more third servers 207.

During the crawling operation (or as part of a separate process) a group of webpage addresses corresponding to a group of webpages 205 may be detected that redirect to other target addresses. First servers 201 may generate a list of one or more target addresses (for example, a URL address reached after a redirection from an original address) from these originating addresses. In this regard, each time an originating address is found to redirect to a target address, the originating address may be stored in storage locations 202, keyed (for example, indexed) by target address. Originating addresses may also include intermediate redirecting addresses. For example, an originating address may be an address that is the target of a first redirect initiated from a first address, and itself initiates a redirect to a final address. Intermediary redirecting addresses, and content of their corresponding resources (for example, webpages) may be stored in the same manner previously described, or not stored.

One or more processors, modules, or computing devices within first servers 101 may initiate a process (for example, a batch process) that queries storage location 202 (for example, at one or more predetermined times each day) to determine how many originating addresses redirect to each stored target address. If a number of originating addresses corresponding to a target address reaches a first predetermined threshold (for example, over twenty), each of the originating addresses may be further analyzed to determine a difference (for example, a numeric value) representative of a difference between previously stored information (for example, visible content or meta-data) corresponding to the originating address, and the information currently associated with the target address. On the difference satisfying (for example, reaching, exceeding, or the like) a second predetermined threshold (for example, a preset value, or an average, or standard deviation from the mean), the redirecting address may be marked as not valid, and the address removed from further crawling operations initiated by first servers 201. In some aspects, first servers 201 may include or support (for example, provide data to) one or more search engines. In this regard, removing webpage 205 or otherwise marking it as invalid may include excluding it from being displayed as part of a search result provided by the one or more search engines.

First servers 201, second servers 204, and third servers 207 may be connected to and/or communicate with each other via the Internet or a remote private LAN/WAN. Likewise, in some aspects, first server 201 and storage location 202 may be connected to and/or communicate with each other via the remote private LAN/WAN or Internet. In some aspects, the various connections between the previously described devices, and/or the Internet or private LAN/WAN, may be made over a wired or wireless connection. In some aspects, the functionality of first server 201 and storage location 202 may be implemented on the same physical server or distributed among a group of servers. Similarly, the functionality of second servers 204 and third servers 207 may be implemented on the same physical server or distributed among a group of servers. Moreover, storage location 202 may take any form such as relational databases, object-oriented databases, file structures, text-based records, or other forms of data repositories.

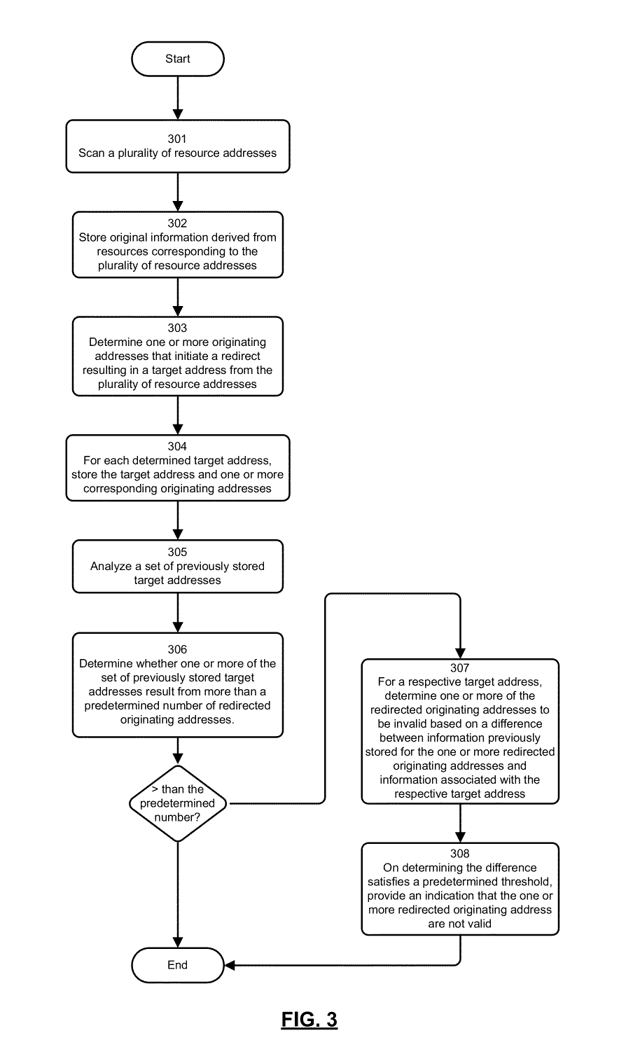

FIG. 3 is a flowchart illustrating an example process for detecting invalid webpages by analyzing server redirects. According to some aspects, one or more processes may be executed by one or more computing devices. In step 301, a plurality of resource addresses are analyzed. In some aspects, each resource address may be an internet address (for example, a URL or Internet Protocol (IP) address) that corresponds to a webpage or other online resource. In step 302, original information derived from resources corresponding to the plurality of resource addresses is stored (for example, in storage location 202). In step 303, one or more originating addresses that initiate a redirect resulting in a target address are determined (for example, identified) from the plurality of resource addresses. A target address may include, for example, a final address of a webpage that provides content resulting from a previous HTTP response that uses 302 HTTP status code of “moved temporarily” or 301 “moved permanently,” or content resulting from a redirect initiated by <meta> tags, JavaScript, or the like. In step 304, for each determined target address, the target address and one or more corresponding originating addresses is stored, for example, in a database indexed by the target address.

In step 305, a set of previously stored target addresses is analyzed. The set may include a subset or all of the target addresses stored as part of step 304. The one or more processes executed by the computing device may, for example, determine the set by querying the previously described database for all stored target addresses, or a subset of target addresses based on one or predetermined parameters (for example, accessed within a date range). In step 306, a determination is made as to whether one or more of the set of previously stored target addresses result from more than a predetermined number of redirected originating addresses. In this regard, the number of redirected originating addresses may be determined from a count of originating addresses that initiate a redirect to the target address, or by reading data associated with target address within the database that indicates the count.

On determining that a respective target address does not result from a redirect initiated from more than the predetermined number of originating addresses, the process may end. Otherwise, on determining that a respective target address results from a redirect initiated from more than the predetermined number of originating addresses, the process may perform steps 307 and 308. In step 307, one or more of the redirected originating addresses are determined to be invalid based on a difference between information previously stored for the one or more redirected originating addresses and information associated with the respective target address. In this regard, a difference between previously stored original information corresponding to the originating address and information corresponding to the respective target address may be determined. In some aspects, the information previously stored for an originating address may include content associated with a webpage located at the originating address, and the information corresponding to the target address may include content associated with a webpage located at the target address. As described previously, the difference may be based on, for example, a comparison of a set of bi-grams determined from the previously stored information and a set of bi-grams determined from the content associated with a webpage located at the originating address. On determining the difference satisfies a predetermined threshold, in step 308, an indication that the one or more redirected originating addresses (already determined to be invalid) are not valid is provided. For example, providing an indication that an originating address is not valid may include marking the originating address as “bad” or removing the originating address from a searchable set of originating addresses, to remove the originating address from a serving search index or from subsequent web crawling operation.

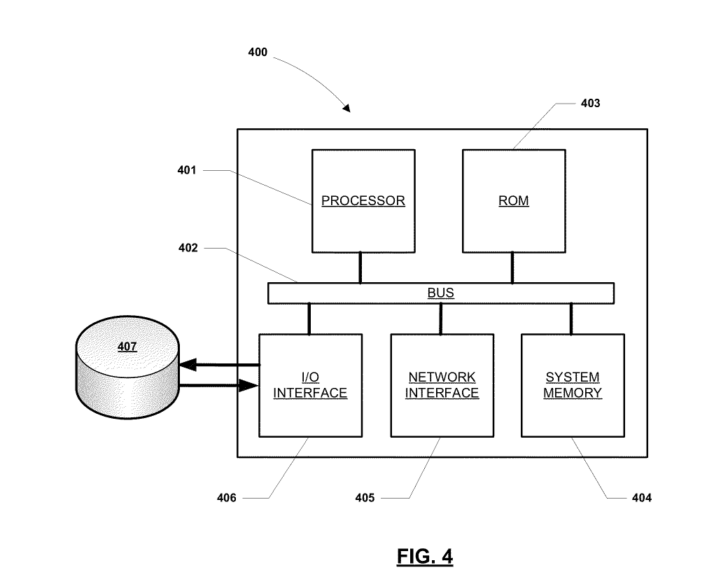

FIG. 4 is a diagram illustrating an example machine or computer for detecting invalid webpages by analyzing server redirects, including a processor and other internal components, according to some aspects of the subject technology. In some aspects, a computerized device 400 (for example, first servers 201, second servers 204, third servers 207, or the like) includes several internal components, for example, a processor 401, a system bus 402, read-only memory 403, system memory 404, network interface 405, I/O interface 406, and the like. In some aspects, processor 401 may also be in communication with a storage medium 407 (for example, a hard drive, database, or data cloud) via I/O interface 406. In some aspects, all of these elements of device 400 may be integrated into a single device. In other aspects, these elements may be configured as separate components.

Processor 401 may be configured to execute code or instructions to perform the operations and functionality described herein, manage request flow and address mappings, and to perform calculations and generate commands. Processor 401 is configured to monitor and control the operation of the components in server 400. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 401. Likewise, one or more sequences of instructions may be software stored and read from system memory 405, ROM 403, or received from a storage medium 407 (for example, via I/O interface 406). ROM 403, system memory 405, and storage medium 407 represent examples of machine or computer readable media on which instructions/code may be executable by processor 401. Machine or computer readable media may generally refer to any (for example, non-transitory) medium or media used to provide instructions to processor 401, including both volatile media, for example, dynamic memory used for system memory 404 or for buffers within processor 401, and non-volatile media, for example, electronic media, optical media, and magnetic media.

In some aspects, processor 401 is configured to communicate with one or more external devices (for example, via I/O interface 406). Processor 401 is further configured to read data stored in system memory 404 or storage medium 407 and to transfer the read data to the one or more external devices in response to a request from the one or more external devices. The read data may include one or more web pages or other software presentation to be rendered on the one or more external devices. The one or more external devices may include a computing system, for example, a personal computer, a server, a workstation, a laptop computer, PDA, smart phone, and the like.

In some aspects, system memory 404 represents volatile memory used to temporarily store data and information used to manage device 400. According to some aspects of the subject technology, system memory 404 is random access memory (RAM), for example, double data rate (DDR) RAM. Other types of RAM also may be used to implement system memory 404. Memory 404 may be implemented using a single RAM module or multiple RAM modules. While system memory 404 is depicted as being part of device 400, it will be recognized that system memory 404 may be separate from device 400 without departing from the scope of the subject technology. Alternatively, system memory 404 may be a non-volatile memory, for example, a magnetic disk, flash memory, peripheral SSD, and the like.

I/O interface 406 may be configured to be coupled to one or more external devices, to receive data from the one or more external devices and to send data to the one or more external devices. I/O interface 406 may include both electrical and physical connections for operably coupling I/O interface 406 to processor 401, for example, via the bus 402. I/O interface 406 is configured to communicate data, addresses, and control signals between the internal components attached to bus 402 (for example, processor 401) and one or more external devices (for example, a hard drive). I/O interface 406 may be configured to implement a standard interface, for example, Serial-Attached SCSI (SAS), Fiber Channel interface, PCI Express (PCIe), SATA, USB, and the like. I/O interface 406 may be configured to implement only one interface. Alternatively, I/O interface 406 may be configured to implement multiple interfaces, which are individually selectable using a configuration parameter selected by a user or programmed at the time of assembly. I/O interface 406 may include one or more buffers for buffering transmissions between one or more external devices and bus 402 or the internal devices operably attached thereto.

Various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description provides various examples of the subject technology, and the subject technology is not limited to these examples. Various modifications to these aspects will be readily apparent, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method, comprising:
analyzing previously stored target addresses;
determining one or more of the previously stored target addresses that result from more than a predetermined number of redirected originating addresses; and
on determining a respective target address, determining that one or more corresponding originating addresses are invalid based on a difference between information previously stored for the one or more corresponding originating addresses and information associated with the respective target address.

2. The computer-implemented method of claim 1, wherein the one or more corresponding originating address are determined to be invalid when the difference satisfies a predetermined threshold.

3. The computer-implemented method of claim 1, further comprising:
analyzing resources corresponding to a plurality of resource addresses, the plurality of resource addresses including the redirected originating addresses,
wherein the previously stored information is derived from resources located at the redirected originating addresses.

4. The computer-implemented method of claim 3, wherein a resource address is an internet address, and the analyzed resources include webpages located at respective internet addresses, and wherein analyzing the resources includes performing a web crawling operation on a plurality of webpages.

5. The computer-implemented method of claim 1, wherein the information previously stored for an originating address includes content associated with a webpage located at the originating address, and
wherein the information associated with the respective target address includes content associated with a webpage located at the respective target address.

6. The computer-implemented method of claim 1, wherein information previously stored for an originating address includes a first set of meta-data associated with the originating address, and the information associated with the respective target address includes a second set of meta-data associated with the respective target address.

7. The computer-implemented method of claim 1, further comprising:
determining a first plurality of n-grams based on terms in information previously stored for an originating address;
determining a second plurality of n-grams based on terms in the information associated with the respective target address;
comparing the first plurality and the second plurality; and
determining a number of matching n-grams between the first plurality and the second plurality, wherein the difference is based on the determined number of matching n-grams.

8. The computer-implemented method of claim 7, further comprising:
before determining the first plurality of n-grams, excluding terms that are in a group of stop words; and
before determining the second plurality of n-grams, excluding terms that are in the group of stop words.

9. The computer-implemented method of claim 1, further comprising:
determining a first semantic content based on terms in the information previously stored for an originating address;
determining a second semantic content based on terms in the information associated with the respective target address; and
comparing the first semantic content with the second semantic content,
wherein the difference is representative of a number of meanings found between the first semantic content and the second semantic content.

10. The computer-implemented method of claim 1, further comprising:
storing the one or more corresponding originating addresses, indexed by the respective target address.

11. The computer-implemented method of claim 1, wherein the redirected originating addresses include one or more intermediate redirecting addresses between a first redirecting address and a final target address.

12. The computer-implemented method of claim 1, further comprising:
providing an indication that the one or more corresponding originating addresses are not valid.

13. The computer-implemented method of claim 12, wherein providing the indication includes removing the one or more corresponding originating addresses from a searchable set of originating addresses.

14. A machine-readable media including instructions thereon that, when executed, perform a method, the method comprising:
determining one or more target addresses that result from a redirection from one or more originating addresses; and
for a target address, storing a plurality of originating addresses, determining that a number of the plurality of originating addresses satisfies a predetermined threshold, and, on determining that the plurality of originating addresses satisfies the predetermined threshold, providing an indication that the plurality of originating addresses is not valid.

15. The machine-readable media of claim 14, the method further comprising:
analyzing a plurality of webpage addresses to determine the one or more target addresses.

16. The machine-readable media of claim 14, wherein determining the one or more target addresses comprises:
determining one or more intermediary addresses that result from the redirection, the one or more target addresses being a result of a redirection from the one or more intermediary addresses; and
storing the one or more intermediary addresses in the storage location together with the plurality of originating addresses.

17. The machine-readable media of claim 16, the method further comprising:
for an intermediary address, if the plurality of originating addresses related to the intermediary address satisfies the predetermined threshold, providing an indication that the intermediary addresses is not valid.

18. The machine-readable media of claim 14, the method further comprising:
storing the one or more target addresses in a storage location; and
analyzing the storage location to determine how many originating addresses redirect to each stored target address.

19. The machine-readable media of claim 14, wherein providing an indication that an originating address is not valid includes removing the originating address from the plurality of originating addresses, and from a subsequent web crawling operation.

20. A system, comprising:
a processor; and
a memory, including server instructions that, when executed, cause the processor to:
analyze a plurality of internet addresses;
store information corresponding to the plurality of internet addresses;
from the plurality of internet addresses, determine one or more target addresses redirected from the plurality of internet addresses;
store the one or more target addresses in a storage location; and
for a target address,
store a plurality of originating addresses,
determine a number of the plurality of originating addresses, and, on determining that the number satisfies a first predetermined threshold, identify originating addresses associated with resources that include different information than a resource associated with the target address, and providing an indication that the identified originating addresses are not valid.
